(19) United States
(12) Patent Application Publication
(10) Pub. No.: US 2010/0021616 A1
(43) Pub. Date: Jan. 28, 2010

(54) Protein supplemented coffee beverage

(76) Inventors: Philip Connolly, Lake Arrowhead, CA (US); James Ernster, Lakewood, CA (US)

Correspondence Address: Paul M. Denk, 763 South New Ballas Rd., St. Louis, MO, 63141, US

(21) Appl. No.: 12/460,141

(22) Filed: Jul. 14, 2009

Related U.S. Application Data
(60) Provisional application No. 61/135,570, filed on Jul. 22, 2008.

(51) Int. Cl. A23F 5/14; A23F 3/14

(52) U.S. Cl. 426/595; 426/590; 426/597

(57) ABSTRACT

A protein supplemented coffee beverage that includes the addition to hot coffee of a quantity of hydrolyzed collagen, a quantity of hydrolyzed whey protein concentrate, and a miniscule amount of natural coffee flavor, for the purpose of supplementing the protein content of the beverage when consumed.

### CROSS REFERENCE TO RELATED APPLICATION

This non provisional patent application claims priority to the provisional patent application having Ser. No. 61/135,570, which was filed on Jul. 22, 2008.

### FIELD OF THE INVENTION

This invention relates to the supplementation of a coffee and related beverage with a supplemental protein to add to the nutritional significance of the brewed beverage.

### BACKGROUND OF THE INVENTION

Previously, people have tried to fortify coffee with commercially available protein sources. Such sources may be casein, whey and soy. Generally, these attempts have all been unsuccessful. The pH of strong coffee is at about the same pH as the isoelectric point (pH 4.6) of casein. When a water soluble forms of casein is added to hot coffee, the casein immediately forms curds and precipitates out of the beverage. Obviously, such condition, visually, is totally unacceptable. Whey proteins do not markedly demonstrate an isoelectric point (i.e., they do not visibly loose water solubility). Therefore, researchers have tried adding whey proteins to coffee. The high temperature of the coffee, however, causes the whey proteins to denature and flocculate. Obviously, still aesthetically unacceptable to the beverage. The acid in the coffee significantly enhances the whey protein flocculation similar to when ricotta cheese is manufactured from cheese whey by heating the whey to 190 degrees F., and adding an acetic acid to the whey. Using whey protein to fortify the coffee does not work much better than a casein. Soy protein precipitates from the hot coffee due to the high temperature and the acid pH. To date, nobody has successfully fortified a hot coffee beverage with nutritionally significant quantities of protein.

### SUMMARY OF THE INVENTION

This invention relates to a protein supplemented coffee beverage, and one that can be prepared that effectively adds protein to the beverage, without changing or displaying any unacceptable appearance to the brewed beverage.

The embodiment of this invention is to produce a coffee based beverage that contains a nutritionally significant amount of supplemental protein, and yet still taste and looks like coffee. It is possible that this type of supplementation may also be added to other brewed beverages, such as tea. As those skilled in the art know, it is more difficult than it sounds to add a supplemental protein to a hot beverage. Coffee is a beverage that is prepared and served at high temperatures, usually temperatures in excess of 190 F, and in addition, coffee has a high acid content (the pH of a strong cup of coffee ranges form pH 4.5 to pH 4.8). It is difficult to find a protein that is stable under the conditions of high temperatures, and the high acid levels, such as found in a brewed cup of coffee. One protein that has shown to produce stable acid pH beverages is hydrolyzed collagen. Collagen is the main protein in animal connective tissues, and can otherwise be termed as a gelatin. Hydrolyze collagen is well know to have a bland flavor profile, to be water soluble, and stable to both acid and high heat. The bland flavor portion of the ingredient allows it to be added, as in this invention, to a brewed pot of coffee, or added to the grounds before brewing, as in the manufacturing process, and will not have any or little effect upon the taste of the brewed beverage. Hydrolyzed collagen has also been shown to be stable and strong, in hot coffee, when added thereto. Collagen, however, is not a nutritionally complete protein. It significantly misses one essential amino acid, tryptophan, and contains very low levels of another amino acid, tyrosine. While a human being could not survive consuming collagen as the only protein source, collagen is considered to be a nutritionally but incomplete protein. While hydrolyzed collagen can be used to fortify coffee with protein, one can not claim that the coffee contains nutritionally significant amounts of supplemental protein, from such an additive.

In recent years, there have been technological advances in whey protein processing. Because whey proteins easily heat denature and will event precipitate from solution in a high heat pasteurized ready-to-drink (RTD) beverage, they have found only minimal usage in RTD beverages. Whey protein manufactures found that the best heat stability of whey proteins improves significantly if they enzymatically hydrolyze the proteins to a slight degree (usually 2% to 5% hydrolysis of peptide bonds). The hydrolysis was of sufficient degree to prevent heat induced water insolubility of the protein, but, at the same time, of sufficiently low degree that the protein's flavor was not impacted. Hydrolyzed proteins typically have unpleasant odors and strongly bitter flavors. The introduction of the slightly hydrolyzed whey proteins has lead to wide spread use of whey proteins in RTD's. Researchers have tried fortifying coffee with these slightly-hydrolyzed whey proteins. While they do perform well in coffee at low usage levels, problems become evident at higher usage levels. For example, if one adds 5 grams of whey protein (5.8 grams of whey protein isolate or 6.5 grams of 80% whey proteins concentrate) to 4 ounces of strong, hot coffee, the coffee turns white (much as if a coffee whitener was added) and a sulfurous flavor and odor can be detected. When adding slightly hydrolyzed whey proteins, the coffee turns a cream color, and a sulfurous odor and flavor is still detected (though not as strong). It is apparent from the white color change and the sulfurous odor in the coffee that the slightly hydrolyzed whey protein is destabilizing when mixed into a hot coffee. For this invention, it was decided to try using a more extensively hydrolyzed whey protein (8% to 12% hydrolysis). Adding such a hydrolyzed whey protein to coffee was found to be an improvement, and the coffee color remained similar to that of the controlled coffee, and there was no sulfurous odor, but the flavor and odor were significantly changed because of the strong odor and objectionable flavor of the hydrolyzed whey protein. The experiment shows that a highly hydrolyzed whey protein, by itself, would not produce an organoleptically acceptable protein fortified coffee.

It is common knowledge that the nutritional quality of an incomplete protein can be significantly enhanced by blending the incomplete protein with a nutritionally high quality protein. The two proteins are said to be complementary to each other, the one protein supplies amino acids in a sufficient quantity to make up for the deficiencies of the other protein, Whey protein is a complementary protein to collagen. A blend of 50% whey protein and 50% collagen has been shown to produce a nutritionally adequate dietary protein. It was decided to try a blend of hydrolyzed whey protein and hydrolyzed collagen in coffee. It was settled on a protein content of 5 grams of protein per 4 ounces of coffee beverage. This would yield a standard 8 ounce cup of coffee, with 10 grams of protein (20% of the U.S. government established daily value for protein consumption).

### DESCRIPTION OF THE PREFERRED EMBODIMENT

A water soluble, heat stable, hydrolyzed collagen can be used that is sourced from beef, pork, or fish gelatin. For the purpose of the present invention, beef gelatin is the preferred source.

The whey protein source is derived from any whey protein isolate or concentrate, with the hydrolyzed versions producing a more preferable coffee beverage from an appearance and organoleptic stand point then the non-hydrolyzed protein. Most preferably, the whey protein isolate or concentrate of 8% 12% degree of hydrolysis is preferred. The quality of the protein fortified coffee increases as the degree of hydrolysis increases from a non-hydrolyzed up towards 8% hydrolysis.

Any natural, natural and artificial, or artificial coffee type of flavor can be used, to supplement the flavor of the beverage. It is not necessary to add a flavor, but it is preferred for consumer acceptance reasons.

By way of example, of a blended coffee treated in the manor of this invention, the following is an example. To 115 grams of hot coffee, there was added 2.75 grams of hydrolyzed collagen, and 3.3 grams of hydrolyzed whey protein concentrate. The final beverage is 4 fluid ounces in volume, and contained 5 grams of nutritious protein. The result in coffee retained its dark color and it did not make detectable any sulfurous odor or flavor noted. Most tasters of the beverage, however, did detect a difference in flavor between the control coffee and the protein fortified coffee. The control coffee had a stronger coffee odor and flavor. When there was added a quantity of 0.5 grams of a natural coffee flavor, all tasters agreed that the protein fortified coffee was very close in flavor and odor to the controlled coffee. Hence, a coffee containing a supplement of hydrolyzed collagen, and a supplement of hydrolyzed whey protein concentrate, added to a hot beverage, such as coffee, and including a minuscule amount of a natural coffee flavor, provides a protein supplemented coffee beverage, with enhanced protein nutrition, but yet still retains all the attributes of a flavorful cup of coffee, to the desire of the consumer.

Variations or modifications to the subject matter of this invention may occur to those skilled in the art upon reviewing the summary of the invention as provide herein, and upon undertake a study of the description of its preferred embodiment. The description of the invention provided herein, and any variations or modifications thereto, are intended to be encompass within the scope of the invention as defined.

1. A protein supplemented coffee beverage including a quantity of hot coffee, an additive of hydrolyzed collagen, an additive of hydrolyzed whey protein concentrate, and a miniscule amount of a natural coffee flavor, to enhance the taste of the brewed beverage.

2. The protein supplemented coffee beverage of claim 1, wherein the hot coffee beverage, there is added approximately 2% of a hydrolyzed collagen, approximately 3% of a hydrolyzed whey protein concentrate.

3. The protein supplemented coffee beverage of claim 2 and including the addition of less than ½% of a natural coffee flavor.

4. A protein supplemented beverage, including a quantity of hot coffee, an additive of hydrolyzed collagen, an additive of hydrolyzed whey protein concentrate, and a miniscule amount of a natural coffee flavor, to enhance the taste of the brewed beverage.

5. The protein supplemented beverage of claim 4 wherein the beverage comprises coffee.

6. The protein supplemented beverage of claim 4 wherein the beverage comprises of hot tea.

7. A protein supplemented coffee beverage for enhancing the protein content of the coffee beverage, including a quantity of hot coffee, the addition of approximately 2% to 3% of a hydrolyzed collagen additive, the addition of approximately 2% to 4% of a hydrolyzed whey protein concentrate, and the addition of approximately less than ½ of a natural coffee flavor by weight.
